(19) United States
(12) Patent Application Publication
(10) Pub. No.: US 2011/0050641 A1
(43) Pub. Date: Mar. 3, 2011

(54) DISPLAY MODULE

(75) Inventors: Wen-Ji Tsai, Taipei County (TW); Bo-Ren Yan, Taichung County (TW); Bo-Yi Wu, Taipei County (TW)

(73) Assignee: QUANTA COMPUTER INC., Tao Yuan Shien (TW)

(21) Appl. No.: 12/619,931

(22) Filed: Nov. 17, 2009

(30) Foreign Application Priority Data
Aug. 25, 2009 (TW) 98215658

(51) Int. Cl. G06F 3/042

(52) U.S. Cl. 345/175

(57) ABSTRACT

A display module is provided. The display module includes a housing, a display panel, a frame, a camera module, and a reflective strip. The display panel is disposed in the housing. The frame is disposed between the housing and the display panel to limit a position of the display panel. The camera module and the reflective strip are disposed on the frame and on a same horizontal level based on the frame. When the display panel is deformed, the camera module and the reflective strip remain on the same horizontal level.

This Application claims priority of Taiwan Patent Application No. 098215658 filed on Aug. 25, 2009, the entirety of which is incorporated by reference herein.

### BACKGROUND OF THE INVENTION

1. Field of the Invention

The invention relates to a display module, and in particular, to a display module with an optical touch system.

2. Description of the Related Art

Referring to FIGS. 1A and 1B, a conventional optical touch display module 10 comprises a liquid crystal display panel (LCD panel) 11, a reflective strip 12 and an optical sensing member 13. The reflective strip 12 and the optical sensing member 13 are directly adhered on the fringe of the surface of the LCD panel 11 in order to set the optical sensing member 13 and the reflective strip 12 on the same horizontal level due to the flat surface of the LCD panel 11. Therefore, the optical sensing member 13 may detect the reflected light beam from the reflective strip 12 to determine whether a contact point exists on the LCD panel 11. However, during the operation of the display module 10, the user must touch the LCD panel 11 for inputting, which may deform the LCD panel 11 due to the external force F (from the touch of the user). As shown in FIG. 1B, when the LCD panel 11 is deformed, the surface of the LCD panel 11 (i.e. horizontal level) where the reflective strip 12 and the optical sensing member 13 are disposed on is twisted, causing the reflective strip 12 and the optical sensing member 13 to shift and rotate relatively to each other. As a result, the optical sensing member 13 cannot properly detect the reflected light beam from the reflective strip 12, and thus miscalculation of the touched location may occur.

### BRIEF SUMMARY OF THE INVENTION

A display module is provided. The display module comprises a housing, a display panel, a frame, a camera module, and a reflective strip. The display panel is disposed in the housing. The frame is disposed between the housing and the display panel to limit a position of the display panel. The camera module and the reflective strip are disposed on the frame and on a same horizontal level based on the frame. When the display panel is deformed, the camera module and the reflective strip remain on the same horizontal level.

Another display module is provided. The display module comprises a housing, a frame, a display panel, a camera module and a reflective strip. The housing, comprises an upper housing and a lower housing. The frame, disposed between the upper housing and the lower housing, comprises a body, an inner surface and a lower surface. The display panel is disposed between the lower housing and the frame contacting the lower surface. The camera module is disposed on the lower surface of the frame. The reflective strip is disposed on the inner surface of the frame. When the display panel is deformed, the display panel is separated from the lower surface.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B are sectional views of a conventional display module;

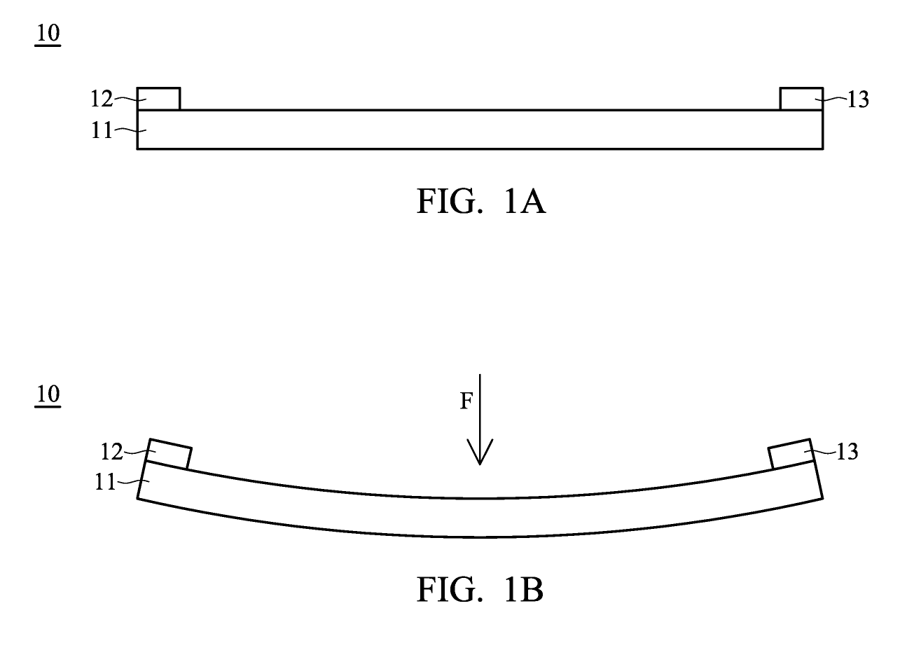

FIG. 2 is an exploded view of a display module of the invention;

FIG. 3A is a bottom view showing a display panel and a frame of the display module of the invention;

FIG. 3B is an enlarged view of a portion A in FIG. 3A;

FIG. 4 is a schematic view of a variant embodiment of the frame of the display module; and

FIG. 5 is a sectional view showing the frame, the display panel, a reflective strip and a camera module of the display module of the invention.

### DETAILED DESCRIPTION OF THE INVENTION

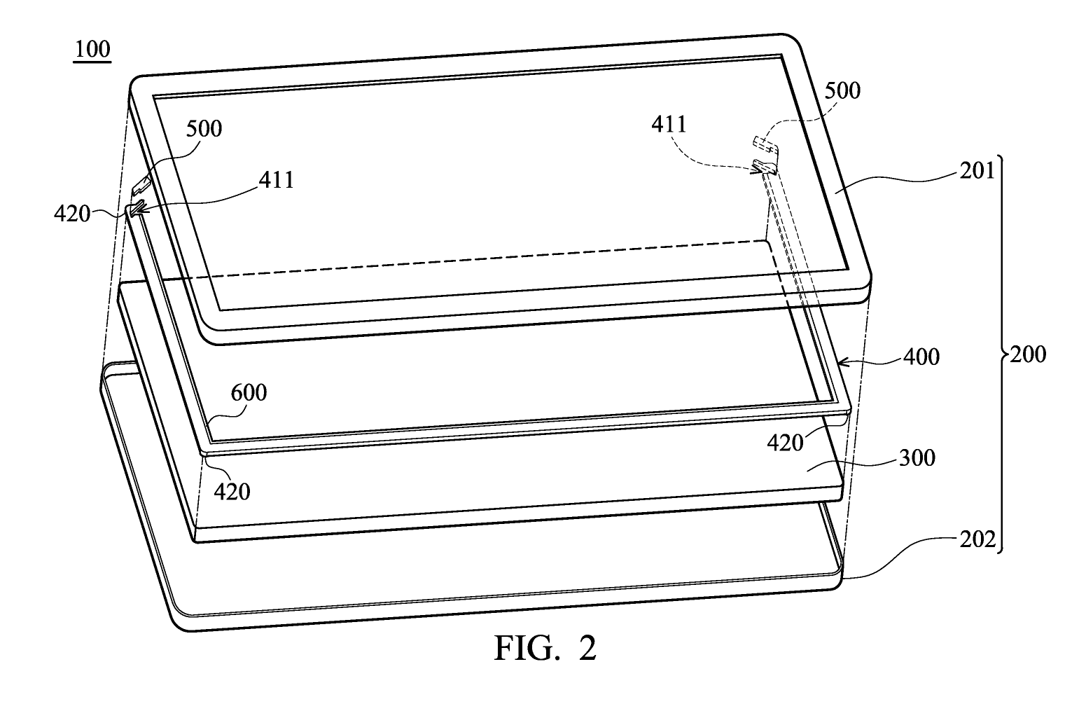

As shown in FIG. 2, the display module 100 of the invention comprises a housing 200, a display panel 300, a frame 400, a camera module 500 and a reflective strip 600, wherein the housing 200 comprises an upper housing 201 and a lower housing 202, and the display panel 300, the frame 400, the camera module 500 and the reflective strip 600 are all disposed between the upper housing 201 and the lower housing 202. Each camera module 500 comprises an optical sensing member.

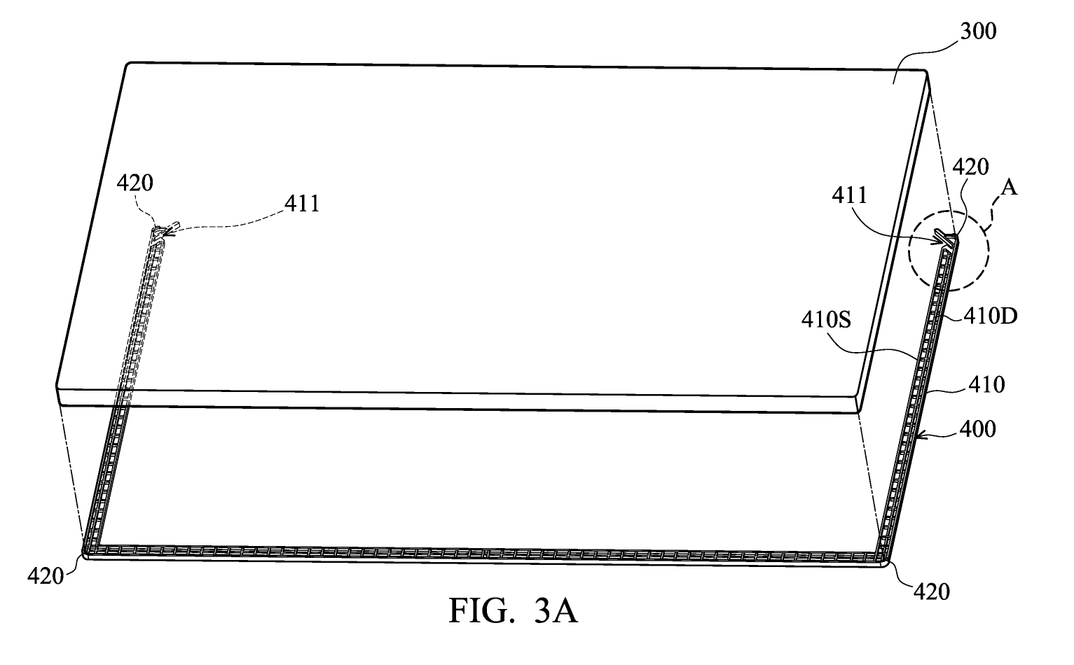

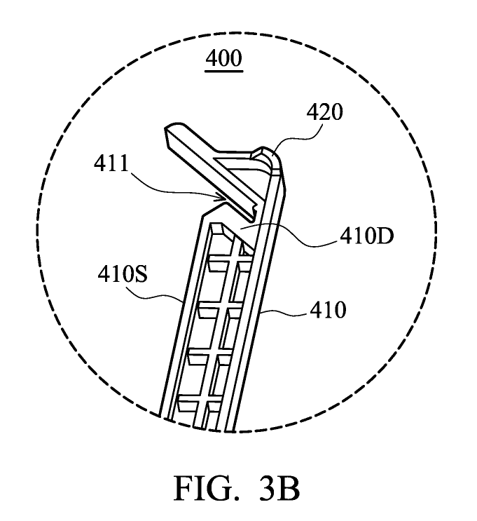

FIGS. 3A and 3B show a bottom view of the frame 400. The frame 400 comprises a body 410 and four flanges 420. The body 410 is U-shaped and defines a space for placing the display panel 300 within. The body 410 has an inner surface 410S and a lower surface 410D. Additionally, on the two ends of the body 410, two recesses 411 are respectively formed thereon. The recess 411 and the four flanges 420 are formed on the lower surface 410D of the body 410, wherein two of the flanges 420 are disposed on the two ends of the body 410 respectively, and the other two flanges 420 are disposed on two corners of the U-shaped body 410. Each flange 420 extends perpendicularly from the body 410, thus each flange 420 is perpendicular to a flat surface formed by the U-shaped body 410 (as shown in FIG. 3B).

Referring to FIG. 2 again, the display panel 300 is disposed in the housing 200 and the frame 400 is also disposed in the housing 200. In detail, the frame 400 is disposed between the upper housing 201 and the display panel 300, thus the inner surface 410S of the body 410 is adjacent to the display panel 300. The camera module 500 is disposed on the body 410, and two optical members are respectively disposed in the recesses 411 on the two ends of the frame 400. The reflective strip 600 is adhered on the inner surface 410S of the body 410 to be adjacent to the display panel 300.

As shown in FIG. 3A, when the frame 400 is disposed on the display panel 300, the position of the display panel 300 is limited between the flanges 420. In other words, the frame 400 does not move relative to the display panel 300 due to the engagement between the flanges 420 and the display panel 300.

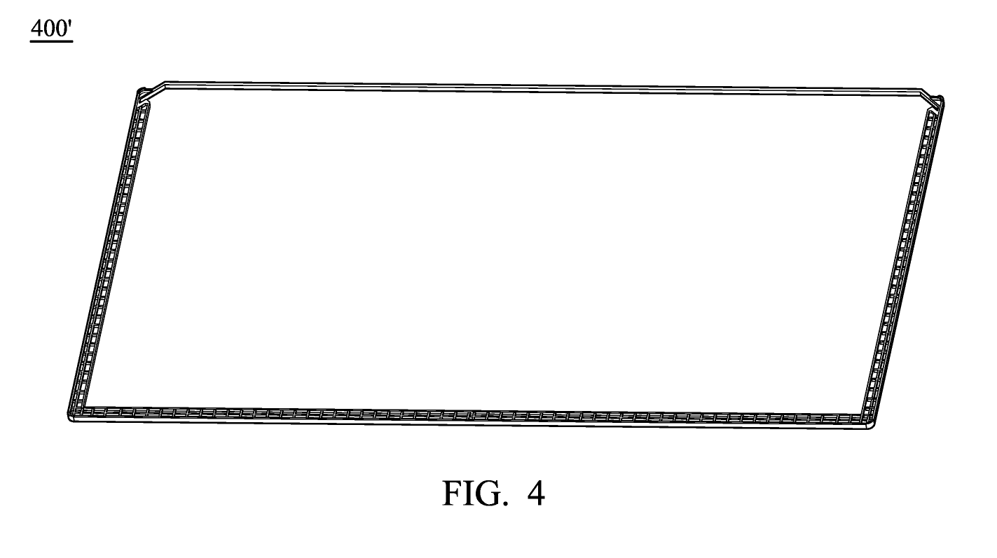

It should be noted that in the embodiment there are four flanges 420 respectively disposed on the ends and corners of the body 410, but it is not limited thereto. The number of the flanges 420 is determined according to requirement, and the flanges 420 can also disposed along the fringe of the body 410, as long as the frame 400 does not move on the display panel 300. Additionally, in the embodiment the frame 400 is U-shaped. Otherwise, as shown in FIG. 4, the frame 400 can also be rectangular-shaped to enhance the structural stability.

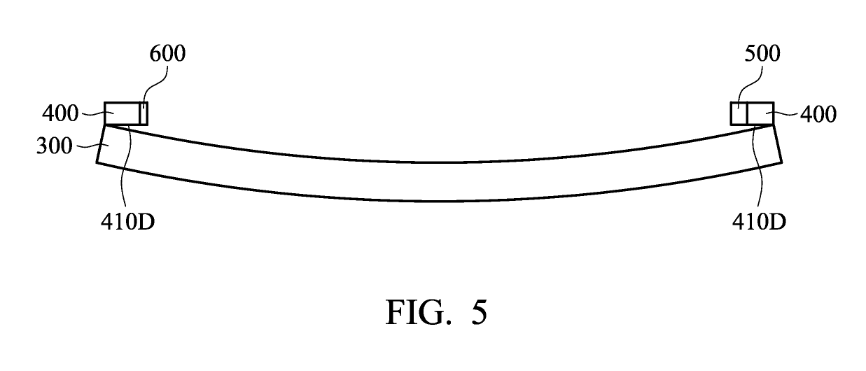

Referring to FIG. 5, after assembling, the frame 400 is stably disposed between the upper housing 201 and the display panel 300, and the lower surface 410D of the frame 400 contacts of faces the display panel 300. As shown in FIG. 5, because the frame 400 is not fixed on the display panel 300, the frame 400 would not be deformed when the display panel 300 is deformed (i.e. the display panel 300 is separated from the lower surface 410D of the frame 400) by an external force. Thus, the camera module 500 and the reflective strip 600 can remain on the same horizontal level based on the frame 400. That is, the horizontal level based on the frame 400 where the camera module 500 and the reflective strip 600 are disposed on would not be changed while the display panel 300 is deformed, thus avoiding shift or rotation between the camera module 500 and the reflective strip 600. As a result, the camera module 500 can properly detect the light beam above the display panel 300, and thus miscalculation of the touched location can be avoided.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display module, comprising:
a housing;
a display panel, disposed in the housing;
a frame, disposed between the housing and the display panel to limit a position of the display panel;
a camera module, disposed on the frame; and
a reflective strip, disposed on the frame and being on a same horizontal level with the camera module based on the frame;
wherein when the display panel is deformed, the camera module and the reflective strip remain on the same horizontal level.

2. The display module as claimed in claim 1, wherein the frame comprises a body and a plurality of flanges, and the flanges are perpendicular to a surface formed by the body, such that the display panel is restricted between the flanges.

3. The display module as claimed in claim 2, wherein the flanges are disposed on corners of the frame, respectively.

4. The display module as claimed in claim 1, wherein the frame has an inner surface adjacent to the display panel, and the reflective strip is adhered on the inner surface.

5. The display module as claimed in claim 1, wherein the frame is in a U-shaped or a rectangular-shaped.

6. The display module as claimed in claim 1, wherein the frame comprises a recess, and the camera module is engaged in the recess.

7. The display module as claimed in claim 1, wherein the frame has a lower surface contacting the display panel, and when the display panel is deformed, the display panel is separated from the lower surface.

8. The display module as claimed in claim 7 wherein the camera module is disposed on the lower surface of the frame.

9. The display module as claimed in claim 1, wherein the camera module comprises two optical sensing members, respectively disposed on two ends of the frame.

10. The display module as claimed in claim 1, wherein the housing comprises an upper housing and a lower housing.

11. A display module, comprising:
a housing, comprising an upper housing and a lower housing;
a frame, disposed between the upper housing and the lower housing, and comprising a body, an inner surface and a lower surface;
a display panel, disposed between the lower housing and the frame, contacting the lower surface;
a camera module, disposed on the lower surface of the frame; and
a reflective strip, disposed on the inner surface of the frame;
wherein when the display panel is deformed, the display panel is separated from the lower surface.

12. The display module as claimed in claim 1, wherein the frame comprises a body and a plurality of flanges, and the flanges are perpendicular to a surface formed by the body, such that the display panel is restricted between the flanges.

13. The display module as claimed in claim 12, wherein the flanges are disposed on the lower surface of the frame.

14. The display module as claimed in claim 13, wherein the flanges are disposed on corners of the frame, respectively.

15. The display module as claimed in claim 11, wherein the inner surface is adjacent to the display panel.

16. The display module as claimed in claim 11, wherein the frame is in a U-shaped or a rectangular-shaped.

17. The display module as claimed in claim 11, wherein the frame comprises a recess, and the camera module is engaged in the recess.
